(19) United States
(12) Patent Application Publication
(10) Pub. No.: US 2021/0020934 A1
(43) Pub. Date: Jan. 21, 2021

(54) POSITIVE AND NEGATIVE ELECTRODE MATERIAL AND PREPARATION METHOD THEREOF

(71) Applicant: GIGA SOLAR MATERIALS CORP., Hsinchu (TW)

(72) Inventors: Wen-Chun Yen, Hsinchu (TW); Wei-Hsiang Huang, Hsinchu (TW); Wei-Kai Liao, Hsinchu (TW); Jian-Shiou Huang, Hsinchu (TW)

(73) Assignee: GIGA SOLAR MATERIALS CORP., Hsinchu (TW)

(21) Appl. No.: 16/930,275

(22) Filed: Jul. 15, 2020

Related U.S. Application Data
(60) Provisional application No. 62/874,961, filed on Jul. 16, 2019.

(30) Foreign Application Priority Data
Jun. 19, 2020 (TW) 109120757

(51) Int. Cl. H01M 4/525; H01M 4/133; H01M 4/1393; H01M 4/36; H01M 10/0525

(52) U.S. Cl. CPC H01M 4/525; H01M 4/133; H01M 2004/021; H01M 4/366; H01M 10/0525; H01M 4/1393

(57) ABSTRACT

A positive and negative electrode material and a preparation method thereof are provided. The positive and negative electrode material includes a powder, a first seed growth layer and a second graft growth layer. A material of the powder includes graphite, silicon based material, lithium titanate, tin oxide, tin alloy, lithium nickel cobalt manganese oxide, lithium nickel cobalt aluminum oxide or lithium iron phosphate. The first seed growth layer is formed radially on a surface of the powder, and the second graft growth layer is radially connected to the first seed growth layer.

### CROSS-REFERENCE TO RELATED APPLICATION

This application claims the priority benefit of U.S. provisional application Ser. No. 62/874,961, filed on Jul. 16, 2019, and Taiwan application serial no. 109120757, filed on Jun. 19, 2020. The entirety of each of the above-mentioned patent applications is hereby incorporated by reference herein and made a part of this specification.

### BACKGROUND OF THE INVENTION

### 1. Field of the Invention

The invention relates to an electrode material and a preparation method thereof, and particularly to a positive and negative electrode material and a preparation method thereof.

### 2. Description of Related Art

In an existing lithium battery industry, a negative electrode of a lithium battery mainly uses graphite materials such as natural graphite or artificial graphite. The graphite has an intrinsic characteristic of low electrochemical potential, and a layered structure of the graphite is just suitable for outward migration and storage of lithium ions. Additionally, the graphite causes a small volume change rate in charging and discharging processes, so that the graphite becomes a mainstream material of a negative electrode of a commercial lithium battery at present. However, in recent years, due to light weight and long-acting output of a 3 C carrier and an electric vehicle, the requirement on the energy density of the battery is also rapidly improved, and graphite with a theoretical specific capacitance of only 372 mAhg-1 cannot meet the requirement of future energy storage batteries gradually. In contrast, lithium silicon compounds having a specific capacitance of 9 to 11 times of that of the graphite become a technology development mainstream of high-energy-density negative electrode materials.

However, due to the high storage capacity characteristics of silicon on the lithium ions, a silicon lattice is forced to expand by about 400% volume when being alloyed with the lithium ions. Such a high volume expansion rate will cause disconnection of the silicon from each other, so that peeling of a pulverized electrode from a current collector is caused. Additionally, a contact area between the silicon and the electrode is reduced, a distance is lengthened, and an electric field cannot effectively act on the electrode, so that the lithium ions and electrons cannot be effectively utilized, rapid degradation of cycles of the battery is caused, and the service life of the battery is greatly reduced. On the other hand, the intrinsic silicon per se has poor conductivity, so that high internal resistance and low heat dissipation speed are caused, and the performance of the battery is greatly influenced. Based on the above, how to avoid falling of a silicon electrode and improve the ion conduction capability of the silicon electrode to prolong the cycle life of a silicon negative electrode is an issue most needed to be preferentially solved for commercialization of the silicon negative electrode at present.

### SUMMARY OF THE INVENTION

The invention provides a positive and negative electrode material and a preparation method thereof. Unsaturated double-bond monomers grow on a surface of a powder through polymeric condensation and free radical polymerization, so as to prolong a cycle life and increase a first cycle efficiency of the powder, and slurry stability may be improved.

The positive and negative electrode material of the invention includes a powder, a first seed growth layer and a second graft growth layer. A material of the powder includes graphite, silicon based material, lithium titanate, tin oxide, tin alloy, lithium nickel cobalt manganese oxide, lithium nickel cobalt aluminum oxide or lithium iron phosphate. The first seed growth layer is formed radially on a surface of the powder, and the second graft growth layer is radially connected to the first seed growth layer.

In an embodiment of the invention, a particle diameter of the powder is in a range of 1 nm to 100 μm.

In an embodiment of the invention, the first seed growth layer and the second graft growth layer are formed by macromolecular monomers containing unsaturated double-bond monomers.

In an embodiment of the invention, the macromolecular monomers containing unsaturated double-bond monomers include unsaturated carboxylic acids, unsaturated amines, unsaturated acrylates, styrene, vinyl cyanide, pyrrole, thiophene, phenylamine or a derivative thereof.

A preparation method of a positive and negative electrode material of the invention includes the following steps: radially growing the first seed growth layer on a surface of a powder through a polymeric condensation process; and growing a second graft growth layer through a free radical polymerization process so that the second graft growth layer is radially connected to the first seed growth layer. A material of the powder includes graphite, silicon based material, lithium titanate, tin oxide, tin alloy, lithium nickel cobalt manganese oxide, lithium nickel cobalt aluminum oxide or lithium iron phosphate.

In an embodiment of the invention, a particle diameter of the powder is in a range of 1 nm to 100 μm.

In an embodiment of the invention, the first seed growth layer and the second graft growth layer are formed by macromolecular monomers containing unsaturated double-bond monomers.

In an embodiment of the invention, the macromolecular monomers containing unsaturated double-bond monomers include unsaturated carboxylic acids, unsaturated amines, unsaturated acrylates, styrene, vinyl cyanide, pyrrole, thiophene, phenylamine or a derivative thereof.

In an embodiment of the invention, in the polymeric condensation process, with respect to 100 g of the powder, an addition amount of the macromolecular monomers containing unsaturated double-bond monomers is in a range of 0.1 g to 10000 g.

In an embodiment of the invention, in the free radical polymerization process, with respect to 100 g of the powder, an addition amount of the macromolecular monomers containing unsaturated double-bond monomers is in a range of 0.1 g to 10000 g.

Based on the above, the invention provides the positive and negative electrode material and the preparation method thereof. The unsaturated double-bond monomers grow on the surface of the powder through polymeric condensation and free radical polymerization. The first seed growth layer and the second graft growth layer are directly formed on the surface of the powder, so as to prolong the cycle life and improve the first cycle efficiency of the powder. The powder is effectively protected from being attacked by an electrolytic solution, and the slurry stability may be improved.

### BRIEF DESCRIPTION OF THE DRAWINGS

FIG. 1A to FIG. 1C are schematic flow diagrams of a preparation method of a positive and negative electrode material according to an embodiment of the invention.

### DESCRIPTION OF THE EMBODIMENTS

In this specification, a range represented by “from a numerical value to another numerical value” is a summary representation that avoids enumerating all numerical values in this range one by one. Therefore, a specific numerical range recorded covers a smaller numerical range defined by a numerical value and another numerical value within this numerical range, as if the numerical values and the smaller numerical range are explicitly written in the specification.

The following makes detailed description by listing embodiments and with reference to accompanying drawings, but the provided embodiments are not intended to limit the scope covered by the invention. In addition, the drawings are drawn only for the purpose of description, and are not drawn according to original sizes.

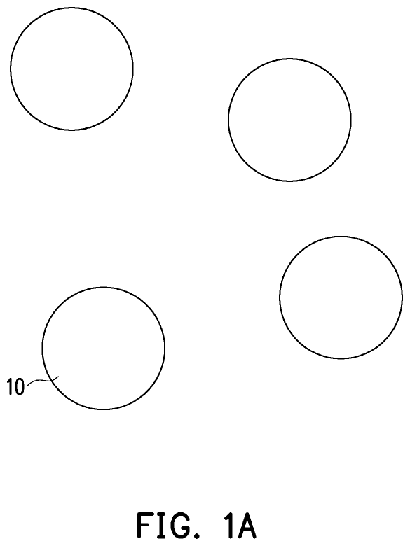

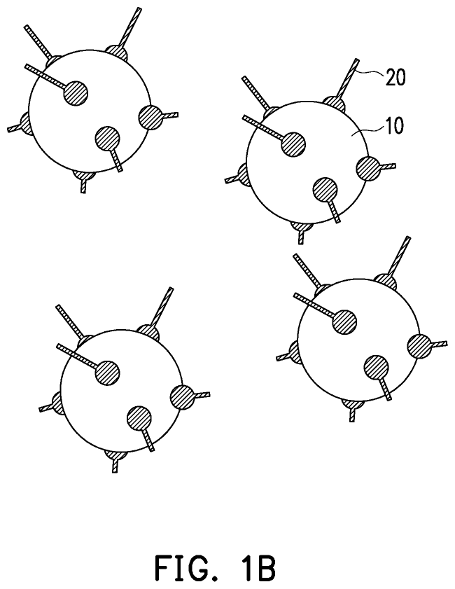

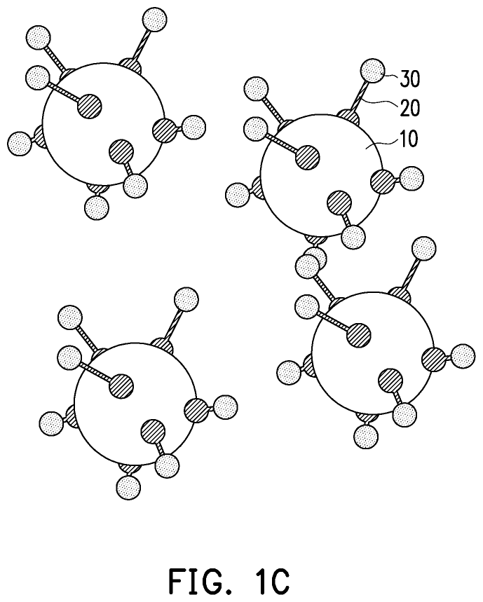

FIG. 1A to FIG. 1C are schematic flow diagrams of a preparation method of a positive and negative electrode material according to an embodiment of the invention.

Referring to FIG. 1A, a powder 10 is provided. A material of the powder may include graphite, silicon based material, lithium titanate, tin oxide, tin alloy, lithium nickel cobalt manganese oxide, lithium nickel cobalt aluminum oxide or lithium iron phosphate. A particle diameter of the powder is, for example, in a range of 1 nm to 100 μm. Then, referring to FIG. 1B, a first seed growth layer 20 radially grows on a surface of the powder 10 through a polymeric condensation process. Next, referring to FIG. 1C, a second graft growth layer 30 grows through a free radical polymerization process, so that the second graft growth layer 30 is radially connected to the first seed growth layer 20. Therefore, the positive and negative electrode material of the invention may be formed. As shown in FIG. 1C, the positive and negative electrode material of the invention includes the powder 10, the first seed growth layer 20 and the second graft growth layer 30. The first seed growth layer 20 is formed radially on the surface of the powder 10, and the second graft growth layer 30 is radially connected to the first seed growth layer 20.

In the present embodiment, the first seed growth layer 20 and the second graft growth layer 30 may be formed by macromolecular monomers containing unsaturated double-bond monomers. In a polymeric condensation process, micromolecular monomers are subjected to excitation by a temperature, a light source (such as radiation and laser), an additive (such as an initiator) and other active substances (such as nanoparticles) or ring opening, functional groups are promoted to react to form polymers through condensation polymerization, and a micromolecular by-product is produced. A reaction temperature of the polymeric condensation process is, for example, in a range of 0° C. to 100° C. With respect to 100 g of the powder, an addition amount of the macromolecular monomers containing unsaturated double-bond monomers is, for example, in a range of 0.1 g to 10000 g. In a free radical polymerization process, micromolecular monomers are subjected to excitation by a temperature, a light source (such as radiation and laser), an additive (such as an initiator) and other active substances (such as nanoparticles), so that unsaturated bonds are promoted to form polymers through addition polymerization. A reaction temperature of the free radical polymerization process is, for example, in a range of 0° C. to 100° C. With respect to 100 g of the powder, an addition amount of the macromolecular monomers containing unsaturated double-bond monomers is, for example, in a range of 0.1 g to 10000 g. The macromolecular monomers containing unsaturated double-bond monomers may include unsaturated carboxylic acids, unsaturated amines, unsaturated acrylates, styrene, vinyl cyanide, pyrrole, thiophene, phenylamine or a derivative thereof. In more details, the unsaturated carboxylic acids may include acrylic acid, methacrylic acid, maleic acid, butene diacid or itaconic acid. The unsaturated amines may include acrylamide, methacrylamide, methylol acrylamide, dimethylacrylamide or isopropylacrylamide. The unsaturated acrylates may include methyl acrylate, ethyl acrylate, butyl acrylate, ethylhexyl acrylate, methyl methacrylate, ethyl methacrylate, butyl methacrylate, ethylhexyl methacrylate, hydroxyethyl methacrylate, hydroxypropyl methacrylate or dimethylaminoethyl methacrylate. However, the invention is not limited thereto.

Hereafter, the positive and negative electrode material and the preparation method thereof of the above embodiment are illustrated in detail by an experimental example. However, the experimental example below is not intended to limit the invention.

### Experimental Example

In order to prove that the positive and negative electrode material and the preparation method thereof of the invention may maintain adhesive force of a certain viscosity and may improve the first cycle coulombic efficiency under the condition of adding no binder, the experimental example is particularly provided hereafter.

In tests below, according to an example, 100 g of macromolecular monomers containing unsaturated double-bond monomers were mixed with 900 g of a silicon based material and a graphite material to be uniformly stirred in a solvent. Polymerization was performed in a 70° C. reaction tank, so that polymers uniformly grew on a surface of a powder material.

### Adhesive Force Test

For an adhesive force test, a material to be tested was mainly coated onto a copper foil and was dried. Then, a specific adhesive tape was used and pasted onto an object to be tested. The object to be tested was milled to and fro for 5 times by a 2 KG milling roller, and was fixed onto an adhesive force test instrument. The adhesive tape was torn down by an electronic scale with an included angle of 90° or 180°. A measured value was adhesive force. The adhesive force of a comparative example (the comparative example at this point was a pure silicon powder) not treated by the preparation method of the positive and negative electrode material of the invention was 0.09 N when no binder was added. In comparison, the adhesive of the example treated by the preparation method of the positive and negative electrode material of the invention was 0.195 N when no binder was added. Therefore, it can be known that the preparation method of the positive and negative electrode material of the invention may enable the positive and negative electrode material to maintain the adhesive force of a certain viscosity under the condition of adding no binder.

### First Cycle Coulombic Efficiency Test

A lithium battery first cycle coulombic efficiency test was performed on a comparative example not treated by the preparation method of the positive and negative electrode material of the invention and an example treated by the preparation method of the positive and negative electrode material of the invention. According to a test method, 90% of a material, 1% of a conducting agent and 4% of a binder were mainly and uniformly stirred with a solvent and were coated onto a copper foil to be dried. Lithium metal was used as a counter electrode to make a half cell. Charging was performed to 0.01 V at 0.1 C, and discharging was performed to 2.0 V at 0.1 C. A material gram capacity might be obtained by dividing a measured capacity by a gram weight. The coulombic efficiency might be obtained by dividing the charging capacity by the discharging capacity. Obtained test results are listed in Table 1. From Table 1, it can be known that compared with the comparative example, the example treated by the preparation method of the positive and negative electrode material of the invention has a result of obviously improving the coulombic efficiency.

TABLE 1

| | | | | First cycle |
|---|---|---|---|---|
| | First cycle | First cycle | First cycle | theoretical |
| | coulombic | theoretical | gram | gram |
| | efficiency | coulombic | capacity | capacity |
| | (%) | efficiency (%) | (mAh/g) | (mAh/g) |
| Comparative | 85.97 | 88 | 478.7 | 550 |
| example | | | | |
| Example | 87.34 | 88 | 550.2 | 550 |

Based on the above, the invention provides the positive and negative electrode material and the preparation method thereof. The unsaturated double-bond monomers grow on the surface of the powder through polymeric condensation and free radical polymerization. The first seed growth layer and the second graft growth layer are directly formed on the surface of the powder, so as to prolong a cycle life and improve a first cycle efficiency of the powder. The powder may be effectively protected from being attacked by an electrolytic solution. Slurry stability is further improved in a subsequent battery slurry mixing process. Dispersibility and uniformity of two to more different powders in the slurry may be further improved, and the two to more different powders may be effectively combined.

What is claimed is:

1. A positive and negative electrode material, comprising:
a powder, wherein a material of the powder comprises graphite, silicon based material, lithium titanate, tin oxide, tin alloy, lithium nickel cobalt manganese oxide, lithium nickel cobalt aluminum oxide or lithium iron phosphate;
a first seed growth layer, formed radially on a surface of the powder; and
a second graft growth layer, radially connected to the first seed growth layer.

2. The positive and negative electrode material according to claim 1, wherein a particle diameter of the powder is in a range of 1 nm to 100 μm.

3. The positive and negative electrode material according to claim 1, wherein the first seed growth layer and the second graft growth layer are formed by macromolecular monomers containing unsaturated double-bond monomers.

4. The positive and negative electrode material according to claim 3, wherein the macromolecular monomers containing unsaturated double-bond monomers comprise unsaturated carboxylic acids, unsaturated amines, unsaturated acrylates, styrene, vinyl cyanide, pyrrole, thiophene, phenylamine or a derivative thereof.

5. A preparation method of a positive and negative electrode material, comprising:
radially growing a first seed growth layer on a surface of a powder through a polymeric condensation process; and growing a second graft growth layer through a free radical polymerization process, so that the second graft growth layer is radially connected to the first seed growth layer,
wherein a material of the powder comprises graphite, silicon based material, lithium titanate, tin oxide, tin alloy, lithium nickel cobalt manganese oxide, lithium nickel cobalt aluminum oxide or lithium iron phosphate.

6. The preparation method of the positive and negative electrode material according to claim 5, wherein a particle diameter of the powder is in a range of 1 nm to 100 μm.

7. The preparation method of the positive and negative electrode material according to claim 5, wherein the first seed growth layer and the second graft growth layer are formed by macromolecular monomers containing unsaturated double-bond monomers.

8. The preparation method of the positive and negative electrode material according to claim 7, wherein the macromolecular monomers containing unsaturated double-bond monomers comprise unsaturated carboxylic acids, unsaturated amines, unsaturated acrylates, styrene, vinyl cyanide, pyrrole, thiophene, phenylamine or a derivative thereof.

9. The preparation method of the positive and negative electrode material according to claim 7, wherein in the polymeric condensation process, with respect to 100 g of the powder, an addition amount of the macromolecular monomers containing unsaturated double-bond monomers is in a range of 0.1 g to 10000 g.

10. The preparation method of the positive and negative electrode material according to claim 7, wherein in the free radical polymerization process, with respect to 100 g of the powder, an addition amount of the macromolecular monomers containing unsaturated double-bond monomers is in a range of 0.1 g to 10000 g.
